(19) United States
(12) Patent Application Publication
(10) Pub. No.: US 2013/0135454 A1
(43) Pub. Date: May 30, 2013

(54) IMAGING DEVICE

(71) Applicant: Makoto Ito, Saitama (JP)

(72) Inventor: Makoto Ito, Saitama (JP)

(21) Appl. No.: 13/570,649

(22) Filed: Aug. 9, 2012

(30) Foreign Application Priority Data
Nov. 25, 2011 (JP) 2011-258037

(51) Int. Cl. H04N 7/18

(52) U.S. Cl. 348/77; 348/E07.085

(57) ABSTRACT

An imaging device including an optical system having a lens; an imaging section that converts a subject image formed on the optical system to an electrical signal; a detecting section that detects a human body using an edge pattern of an image signal obtained by the imaging section; and a control section that drives the lens to perform focus control based on a change in a size of the human body detected in time series in a plurality of images.

### CROSS-REFERENCE TO RELATED APPLICATION

This application claims priority to Japanese Patent Application No. 2011-258037 filed on Nov. 25, 2011, which is incorporated herein by reference in its entirety.

### FIELD OF THE INVENTION

The present invention relates to an imaging device, and more particularly, to focus control related to imaging devices.

### BACKGROUND OF THE INVENTION

Techniques for detecting a human body as a subject in an image captured by photography has been proposed.

For example, Japanese Patent Publication JP 2005-149145 discloses an object detecting device having a template managing section that stores templates each formed with a closed curved line representing a portion of outline of a model of a human body or a portion of the human body, an image data receiving section that receives an image to be detected as input, and a head position detecting section that detects a human body in the image by matching the input image to a plurality of templates.

Further, Japanese Patent Publication JP 2003-132340 discloses a person shape determination method including an outline extracting section that extracts outline data of a determination target included in a two-dimensional image, a shape value generating section that calculates a ratio of a straight-line portion and a curved-line portion of the outline from the extracted outline data, and a determining section that determines the presence of a person by comparing a predetermined threshold with the ratio of the straight-line portion and the curved-line portion of the outline data calculated by the shape value generating section.

Japanese Patent Publication JP 2010-117772 discloses a device having an edge image extracting section that forms an edge image from an image, and a feature calculating section that calculates the number of edge pixels defined by a direction of an edge in a predetermined pixel and a direction of an edge in an edge pixel present in a neighboring area of the predetermined pixel, and a spatial relationship between the predetermined pixel and the edge pixel present in the neighboring area, as a feature of the image, for improving the identification accuracy of human figures in an image.

Further, Japanese Patent Publication JP 2007-248698 discloses storing information on standard face sizes and calculating an actual distance to the face of a subject based on this standard size and the size of the face which has been photographed.

Still further, Japanese Patent Publication JP 2002-298142 discloses a technique of determining whether or not a subject is a person based on the ratio of the sizes of the head to the body.

### SUMMARY OF THE INVENTION

Although the above-described techniques make it possible to detect that an image being captured includes a person or human shape when capturing an image using an imaging device such as a digital camera, there has been relatively little thought given to how to apply the detection information when a person or human shape has been detected.

For example, JP 2005-149145 merely discloses using a technique for detecting a human body from an image for facility security purposes, and nowhere discloses employing that information widely, such as in techniques for controlling image capturing by a digital camera.

It is therefore an object of the present invention to provide a device that detects a human body included in a photographed image and performs focus control utilizing the detection information.

In the imaging device according to the present invention, the imaging device includes an optical system including a lens, an imaging section that converts a subject image formed on the optical system to an electrical signal, a detecting section that detects a human body using an edge pattern of the image signal obtained by the imaging section, and a control section that drives the lens to perform focus control based on a change in the size of the human body detected in time series in a plurality of images.

In the present invention, an edge is extracted from the image signal obtained by the imaging section, and the pattern of this edge is used to detect a human body. That is, when the pattern of the edge corresponds to a pattern specific to or commonly associated with a human body, this pattern is detected as a human body. In the present invention, such human body detection processing is carried out in time series, that is, at least two different timings, so that results of human body detection are obtained at the different timings. The focus control is performed based on a change in size of the human body captured at the two different timings, that is, based on whether the size of the human body becomes larger or conversely becomes smaller. Because the apparent size of a human body becomes larger when the relative distance between a person which is a subject and the imaging section which photographs this person becomes smaller, the focus is controlled to a shorter range. On the other hand, because the apparent size of a human body becomes smaller when the relative distance between the person which is a subject and the imaging section which photographs this person becomes larger, the focus is controlled to a longer range when this is detected. In this way, by performing focus control based on the change in size of the human body obtained by human body detection, it is possible to effectively utilize the human body detection results and carry out the focus control stably and rapidly. Focus control is typically performed based on contrast-based focus control or phase difference focus control, while the focus control of the present invention, which is performed based on the human body detection results, can be combined with the contrast-based focus control or the phase difference focus control to complement these methods.

According to the first embodiment of the present invention, the control section performs focus control by driving the lens based on the change in the size of the human body, and then driving the lens until the lens reaches a position where contrast of the image becomes maximum.

Further, according to another embodiment of the present invention, the control section performs focus control by driving the lens based on the size of the human body when there is substantially no change in the size of the human body.

Still further, according to still another embodiment of the present invention, the control section drives the lens to a shorter range position when the size of the human body increases in time series, and drives the lens to a loner range position when the size of the human body decreases in time series.

According to the present invention, it is possible to perform focus control using human body detection information, so that it is possible to carry out focus control more stably or more rapidly.

### BRIEF DESCRIPTION OF THE DRAWINGS

Preferred embodiments of the present invention will be described in detail based on the following figures, wherein:

FIG. 1 shows a configuration of a digital camera according to an embodiment of the present invention;

FIG. 2 is a flowchart showing focus control as employed in an embodiment of the present invention;

FIG. 3 is a flowchart showing human body detection according to an embodiment of the present invention;

FIG. 4 explains an edge pattern of a human body;

FIG. 5 explains a lens moving position according to an embodiment of the present invention; and

FIG. 6 is a graph showing the relationship between an amount of change in size of a detected human body and the amount of movement of a lens.

While the preferred embodiments of the present invention are described using specific terms, such description is for illustrative purposes only, and it is to be understood that changes and variations can be made without departing from the spirit or scope of the appended claims.

### DETAILED DESCRIPTION OF THE INVENTION

Preferred embodiments of the present invention will be described in detail with reference to the accompanying drawings.

The embodiments of the present invention will be described below with reference to the drawings. However, the following embodiments are merely examples, and the present invention is not limited to the following embodiments.

First, a basic configuration of a digital camera serving as an imaging device according to an embodiment of the present invention will be described.

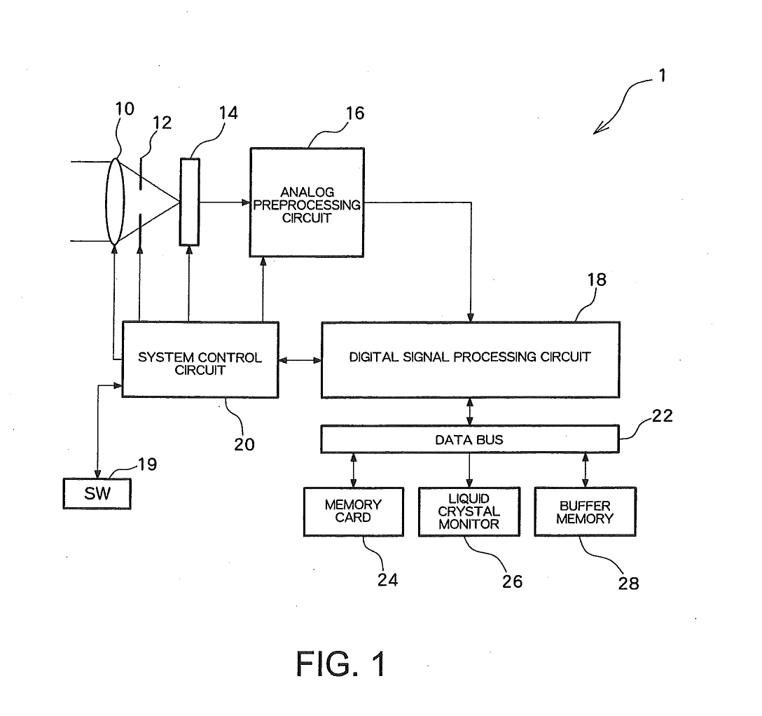

FIG. 1 is a block diagram showing an example configuration of a digital camera according to the present invention. A subject image is formed on an imaging element 14 through a lens 10 and a shutter/diaphragm 12. The imaging element 14 converts the subject image into an electrical signal and outputs the electrical signal to an analog preprocessing circuit (analog front end) 16 as an analog image signal. The diaphragm is driven and controlled with an exposure control signal supplied from a system control circuit 20 (automatic exposure control: AE). Further, the lens 10 is driven and controlled with a focus control signal supplied from the system control circuit 20 (automatic focus control: AF).

The imaging element 14 includes an optical filter such as an IR cutoff filter, an optical low pass filter or a color filter array. A CCD imaging element or a CMOS imaging element is used as the imaging element 14.

The analog preprocessing circuit (analog front end) 16 includes an analog amplifier, a gain controller and an AD converter, and is configured to amplify the analog image signal supplied from the imaging element 14, convert the analog image signal into a digital image signal and output the result to a digital signal processing circuit 18.

The digital signal processing circuit 18 performs processing for gain correction (adjustment of white balance), gamma correction, synchronization processing, RGB-YC conversion, noise reduction processing, outline correction and JPEG compression on the supplied digital image signal.

The gain correction (adjustment of white balance) is processing for correcting balance of RGB according to light source color temperature, in which the gains of the input R signal, G signal and B signal are adjusted. A method for adjusting the gains includes a method of adjusting the gains based on types of the light source (such as sunlight and electric light) or the like entered by a user manually, a method of performing correction by photographing a white or gray object placed under a light source for photographing with a camera, and a method of performing correction by automatically judging a light source with a camera (auto white balance).

The gamma correction is processing for adapting output characteristics of the imaging element 14 to input and output characteristics of a display.

In a single-plate imaging system which uses a Bayer color filter array, only a signal of one color exists in one pixel. Therefore, in the synchronization processing, signals for other colors are computed and calculated from color signals in the neighboring pixels. A method of the synchronization processing includes a method of averaging values of the neighboring pixels, and a method of performing weighted averaging according to the distance from a pixel of interest.

The RGB-YC conversion processing is processing for converting the R signal, G signal and B signal subject to the synchronization processing into Y signal, Cb signal and Cr signal. That is, the signals are converted into the Y signal which is a luminance signal, and the Cb signal and Cr signal which are color-difference signals by the following expressions:

Y=0.30R+0.59G+0.11B

Cb=B−Y

Cr=R−Y

The noise reduction processing is processing for removing isolated points such as pulsed noise using a median filter or the like. Although noise is eliminated by this processing, as this processing also lowers resolution at the same time, this processing is typically implemented on the color-difference signals Cb and Cr.

The outline correction processing is processing for correcting a decrease in the MTF (Modulation Transfer Function) caused by an influence of an optical low pass filter, or the like, in which an outline signal is added to an original image signal by the outline extraction processing and non-linear processing. Typically, the luminance signal is subjected to the outline correction processing.

In JPEG compression, the Y signal which is the luminance signal and the Cb signal and Cr signal which are the color-difference signals are compressed by being respectively divided into blocks of 8×8 pixels and sequentially subject to DCT conversion, quantization and Huffman coding for each block.

The digital signal processing circuit 18 stores the image signals compressed through the above-described processing in a buffer memory 28 through a data bus 22, reads out the image data stored in the buffer memory 28, and then displays the data on a liquid crystal monitor 26 or stores the image signals in a memory card 24.

The system control circuit 20 controls the operation for each section based on the signals input from various operation switches (SW) 19. For example, the system control circuit 20 controls the operation of each section based on an operation signal of a shutter button to display an image created by the captured image signals on the liquid crystal monitor 26 or to store the image signals in the memory card 24. Further, during photography, the system control circuit 20 carries out automatic exposure control (AE) and automatic focus control (AF) as described above. The focus control includes contrast detection type AF and TTL phase difference detection type AF. In the contrast detection type AF, a point in the captured image where contrast is maximum is set as a focus position, and the focus is moved a small amount from the current position. The focus is moved in the opposite direction when the contrast decreases and forward when the contrast increases, until, when the focus decreases when moved in either direction, the position is set as the focus position (“mountain climbing method”). In the TTL phase difference detection type AF, a distance measuring unit measures a light transmitted through the lens and determines a focus position of the lens. In this TTL phase difference detection type AF, because an image moves to the right or left according to a direction of displacement from the focus position and the degree of displacement, the distance measuring unit determines the focus position by utilizing this movement of the image.

In such a configuration, the digital signal processing circuit 18 carries out the above-described processing, carries out human body detection processing for detecting whether or not the obtained image signal includes a human body, and outputs the detection result to the system control circuit 20.

The system control circuit 20 carries out focus control using the human body detection information from the digital signal processing circuit 18. That is, the system control circuit 20 carries out the focus control using the human body detection information in addition to the conventional focus control. Specifically, the system control circuit 20 performs focus control by detecting a change in relative distance between a person which is a subject and the camera by utilizing a change in the size of the human body included in the human body detection information and driving the lens 10 accordingly. In that sense, the “human body detection” in this embodiment includes processing related to determining whether or not the photographed image includes a human body, and, when a human body is detected, detecting the size of the human body within the image being photographed. The size of the human body is specifically the size of the upper body of the human body, and the size of the upper body includes the size of the head (length and width of the head), the size of the shoulders (width of the shoulders), and the ratio between the size of the head and the width of the shoulders. The size is defined by the number of pixels constituting the image of the head and shoulders.

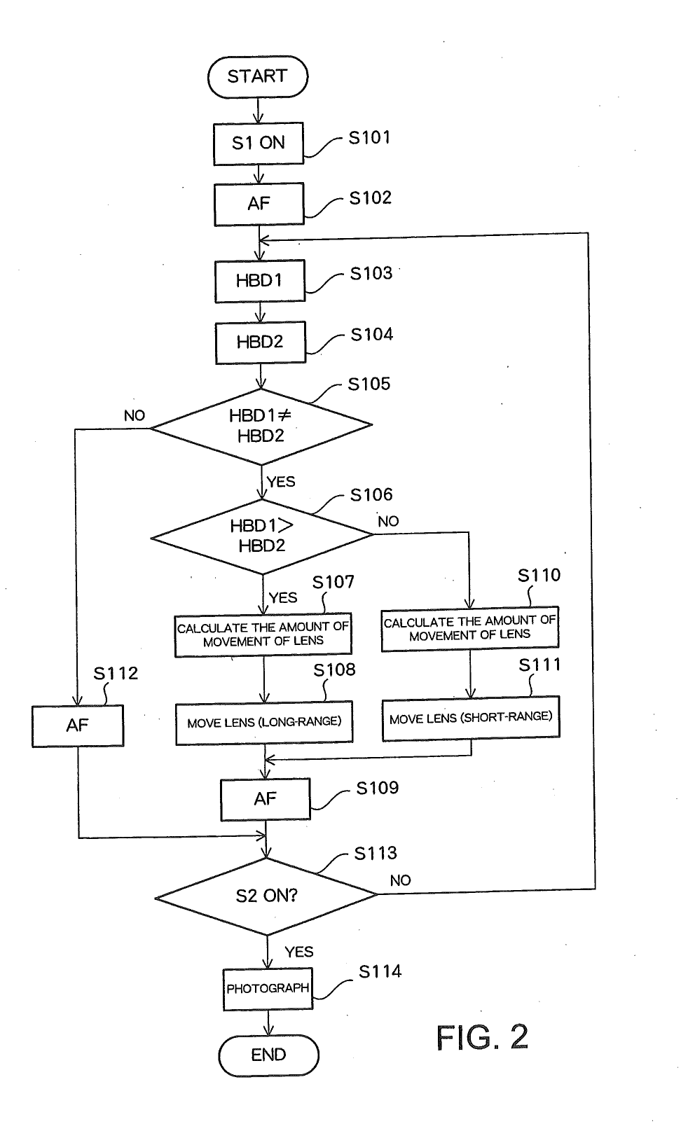

FIG. 2 is a flowchart showing the processing of the focus control according to this embodiment. First, when a user depresses a shutter button halfway to turn on S1 (S101), the system control circuit 20 first causes the imaging element 14, the analog preprocessing circuit 16, and the digital signal processing circuit 18 to operate to repeatedly read the photographed image signal of the imaging element 14, and displays the signal on the liquid crystal monitor 26 via the data bus 22. Further, the system control circuit 20 carries out contrast AF using the read image signal to perform focus control (S102). Then, the digital signal processing circuit 18 detects a human body in the photographed image signal read by the imaging element 14 at a certain timing (which is set as t1) (S103). Hereinafter, the human body detection processing and the detection result obtained from this detection processing are collectively referred to as HBD (Human Body Detection), and the human body detection result obtained at the time t1 is referred to as HBD1. Further, the digital signal processing circuit 18 detects a human body in the photographed image at the next timing (which is set as t2) (S104). The human body detection result obtained at the time t2 is referred to as HBD2. The human body detection HBD is described in detail further below.

After the human body detection results HBD1 and HBD2 are obtained at the predetermined times t1 and t2, the digital signal processing circuit 18 determines whether or not these human body detection results are identical (S105) by determining whether or not the sizes of the human bodies obtained by the human body detection are substantially the same.

For example, the lengths of the heads of the human bodies in the image detected by the HBD are defined as the sizes, and whether or not these sizes are substantially equal is determined by determining whether or not the difference between the sizes falls within a predetermined permissible range.

The size of the human body can be defined by the width of the head, the width of the shoulders, the sum of the width of the head and the width of the shoulder, the sum of the length of the head and the length of un upper body, or a composite combination of any of these measurements, as well as the length of the head in the image. Because the human body is detected using an edge pattern extracted from the captured image, the size is preferably detected using an edge pattern specific to the human body which is extracted upon extraction. Specifically, when the human body is detected using a combination of a curved edge of the head and a curved edge of the shoulder, the width of the edge of the head in the image is regarded as the size of the human body, or the sum of the width of the edge of the head and the width of the edge of the shoulders can be preferably regarded as the size of the human body.

The size of a human body in an image can change according to a change in the orientation of the person with respect to the camera as well as to a change in the relative distance between the subject and the camera. For example, when the width of the head in the image is defined as the size of the human body, a change in head width when the person turns their head can be ignored because the change in size caused by this orientation is smaller than the change in size caused by a change in the distance. Of course, it is also possible to take into account changes in size caused by changes in orientation by defining the size of a body part whose size does not change significantly when the orientation of the person changes as the size of the human body. For example, it is possible to define the sum of the length of the head and the length of the upper body as the size of the human body.

When the human body detection results HBD1 and HBD2 are not identical, the digital signal processing circuit 18 then determines whether or not HBD1 is larger than HBD2, that is, whether or not the size of the human body obtained at the time t1 is larger than the size of the human body obtained at the time t2 (S106). When it is determined that HBD1 is larger than HBD2, it is determined that this is because the person in the photographed image has moved away from the camera, and this determination result is output to the system control circuit 20. The system control circuit 20 calculates the amount of movement of the lens in consideration of the difference between HBD1 and HBD2 according to the determination result from the digital signal processing circuit 18 (S107). Specifically, for example, the amount of movement corresponding to the difference can be determined with reference to a table that defines the relationship between the difference between the detection results and the amount of movement of the lens, which is stored in advance in a memory. Then, the system control circuit 20 moves the lens 10 to a longer range position by the calculated amount of movement of the lens (S108). The amount of movement of the lens is calculated in S107 because, even if the movement of the subject can be detected from the comparison between the HBD1 and the HBD2, the detected movement becomes pointless if the lens 10 is moved too far and passes the focus position.

On the other hand, when the HBD1 is smaller than the HBD2 (when the determination at S106 is NO), it is determined that this is because the person in the photographed image has moved closer to the camera, and this determination result is output to the system control circuit 20. The system control circuit 20 calculates the amount of movement of the lens from the difference between HBD2 and HBD1 according to the determination result from the digital signal processing circuit 18 (S110), and moves the lens 10 to a shorter range position by the calculated amount of the movement of the lens (S111).

As described above, after moving the lens 10 to either a longer or shorter range position by an amount of lens movement determined according to the difference between HBD1 and HBD2, the system control circuit 20 further carries out the contrast detection type AF (S109). That is, the system control circuit 20 moves the lens from its current position by a small amount, and then, when the contrast decreases, moves the lens in back in the opposite direction, or, when the contrast increases, continues to move the lens forward in the same direction. When a position is reached where the contrast decreases when the lens is moved in either direction, this position is set as the focus position. Because the lens 10 is initially moved in the correct direction at S108 or S111, the focus position can be determined faster compared to conventional techniques.

Further, when HBD 1 and HBD2 are identical (when the determination at S105 is NO), it is determined that the person is not moving with respect to the camera, and this determination result is output to the system control circuit 20. The system control circuit 20 calculates the distance to the person based on the determination result and HBD1 or HBD2, and carries out AF (S112). That is, the distance between the camera and the person is determined uniquely from the values HBD1 or HBD2, and the lens 10 is moved according to the determined distance. Specifically, the distance corresponding to the size of HBD 1 or HBD2 is determined with reference to a table, which is stored in advance in a memory, that defines the relationship between size and distance. As an example, a table that defines the relationship between the size of the head and the distance to the subject with respect to the focal length of the lens is pre-stored in a memory. For example, the table includes values for vertical head size (length of the head) A, the focal length of 28 mm, and the distance to the subject of 50 cm. The above JP 2007-248698 discloses storing the standard size of the face and calculating an actual distance to the subject from this size and the size of the photographed face. Of course, the position of the lens 10 can be maintained without change when HBD1 and HBD2 are identical, because it can be understood that the relative distance between the person which is the subject and the camera is not substantially changing.

Although the above description is based on the assumption that the actual size of the upper body of a person is known, the actual size of the upper body of the person can change according to the age of the person. For example, most children are smaller than most adults. It is therefore also possible to estimate the age of the person from HBD1 or HBD2 and determine the distance between the camera and the person from the size and the estimated age. Specifically, it is possible to calculate the ratio of the length of the head to the width of the shoulders in HBD1 or HBD2 and estimate the age of the person based on the using the calculated ratio. Generally, children have larger heads relative to their bodies, and the ratio of the length of the head to the width of the shoulder of a child becomes larger than the ratio of an adult. Therefore, the age corresponding to the ratio in HBD1 or HBD2 can be determined with reference to a table, which is stored in advance in the memory, that defines the relationship between ratios and ages. Of course, because this ratio can vary according to gender and nationality, the age can be estimated taking into account these factors. After the age is estimated, the distance to the person is determined with reference to a table, which is stored in advance in the memory, that defines the relationship between the age, the size of HBD within the image, and the distance.

In the processing at S112, it is also possible to carry out the contrast detection type AF in a complementary manner in addition to the focus control carried out based on the size of HBD. That is, it is also possible to determine the focus position where the contrast becomes maximum by determining the distance with reference to the table, after moving the lens 10, moving the lens 10 further from the position to detect the change in contrast. After the focus control is carried out as described above, the user depresses the shutter button fully and determines whether or not S2 is turned ON (S113), and, when it is determined that the S2 is turned ON, the system control circuit 20 performs photographing processing (S114) to display the captured photographed image on the liquid crystal monitor 26 and store the image in the memory card 24. If the S2 is not turned ON, the processing after S103 is repeated.

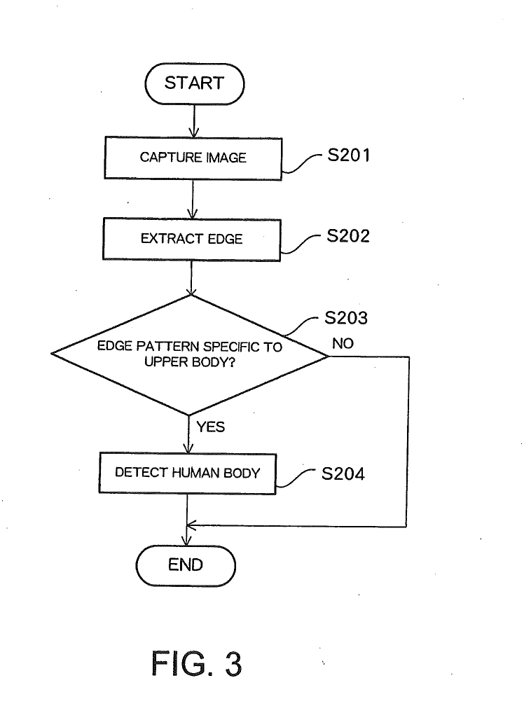

FIG. 3 is a flowchart showing an example of human body detection processing. First, the digital signal processing circuit 18 captures an image from the above processing (S201). Next, an edge is extracted from the captured image (S202). It is possible to employ an outline extraction result obtained by the outline correction processing to this edge extraction processing, or extract an edge separately from the outline extraction result.

After the edge is extracted, the digital signal processing circuit 18 determines whether or not a pattern of the extracted edge matches a predetermined edge pattern of an upper body of the person (S203), which is stored in a memory of the digital signal processing circuit 18 in advance as a template. When the pattern of the extracted edge matches the edge pattern of the upper body, a human body is detected from the extracted edge (S204).

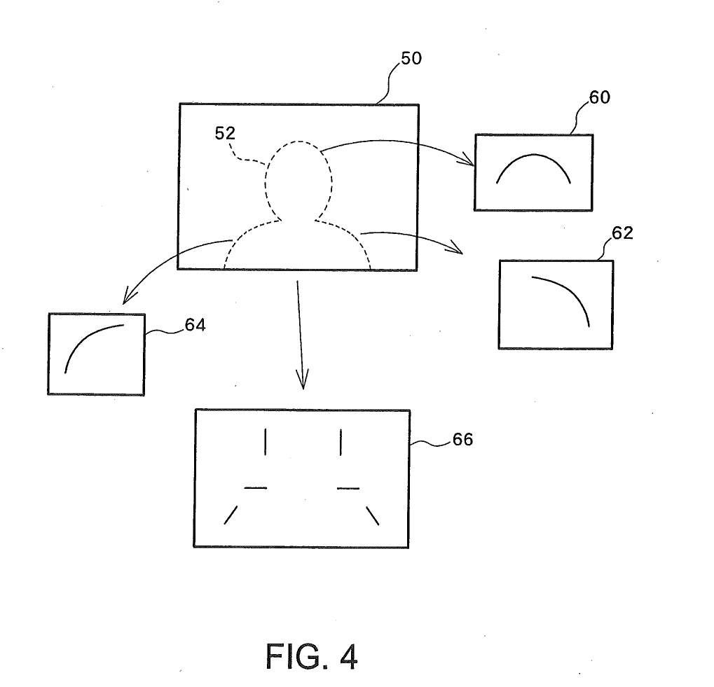

FIG. 4 schematically shows an example of processing for detecting a human body in a photographed image 50, assuming that a human body 52 appears in the photographed image 50. The image includes a curved-line edge 60 corresponding to the head of the human body and curved-line edges 62 and 64 corresponding to the shoulder of the human body. Whether or not there is a pattern that matches these edges 60, 62 and 64 among the edges extracted from the photographed image is determined using these edges 60, 62 and 64 which are stored in a memory as templates. Because a human body 52 in the photographed image 50 can be of any size, any pattern having a similar shape can be considered as a pattern that matches the template. It is also possible to prepare a plurality of templates of different sizes in advance. In this way, a human body can be detected from the image by detecting the edge of the head and the edges of the shoulders.

Alternatively, it is also possible to prepare a combination 66 of straight-line edges of the head and straight-line edges of the shoulders as a template.

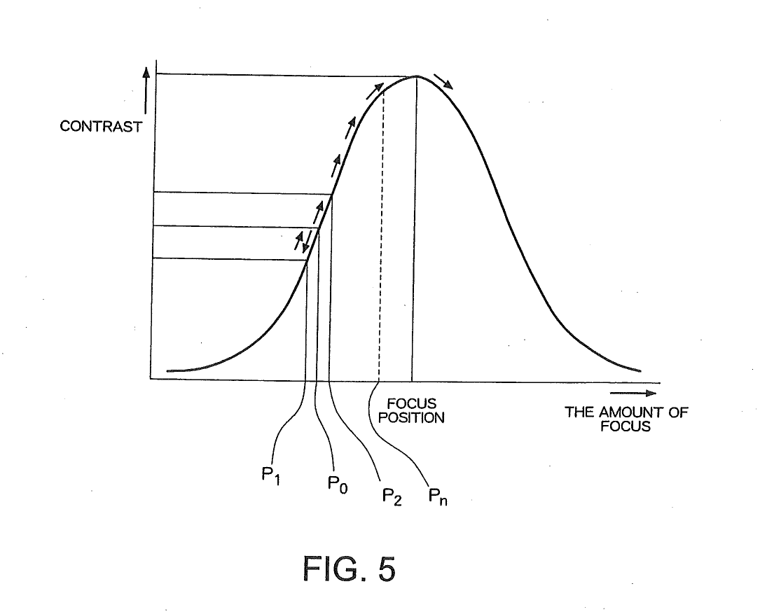

FIG. 5 shows an example of focus control in this embodiment, wherein the horizontal axis indicates the amount of focus (position of the lens), the vertical axis indicates contrast of the image, and P0 is assumed to be a current position of the lens 10. In typical contrast-based AF, the lens 10 is moved, for example, in the direction of P1 from P0 to detect a change in contrast. When the contrast decreases at P1 from the contrast at P0, the lens is moved to P2 which is in the direction opposite to P1 with respect to P0, and the change in contrast is again detected. When the contrast increases at P2 from the contrast at P0, the lens 10 is further moved in the same direction. After movement in the same direction is repeated a plurality of times (P2, P3, P4, Pn, Pn+1, . . . ) until a position is reached where movement in either direction would cause contrast to decrease, a position where the contrast becomes maximum is determined as a focus position.

In contrast to this conventional method, in the processing employed in this embodiment of the present invention, whether the lens 10 is initially moved to shorter or longer range direction is determined according to the relationship of the sizes of HBD1 and HBD2. For example, the lens can be moved from P0 to Pn. Then, the contrast-based AF is carried out from Pn as a starting point, with the result that the focus position can be determined faster than when employing conventional techniques alone.

The HBD1 is detected in a state wherein focus control is performed based on a normal contrast-based AF, and HBD2 is detected while the focus is maintained in that state. Therefore, HBD2 is detected at a position where the focus is blurred to some extent; however, this does not present a problem because, focus is sufficient as long as the focus is not blurred to the extent that edge pattern detection becomes impossible.

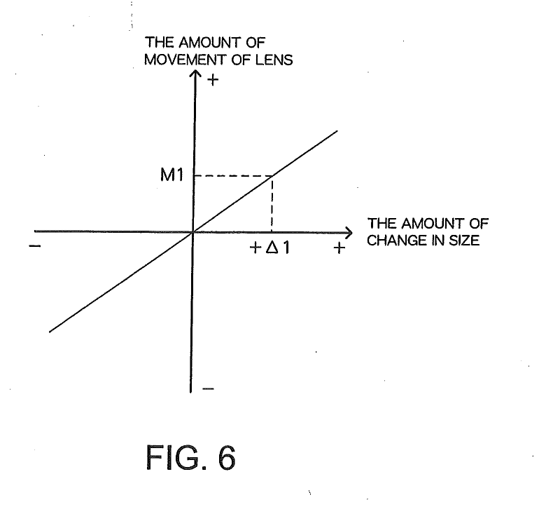

FIG. 6 shows an example relationship between the amount of change between sizes of HBD1 and HBD2 and the amount of movement of the lens when the amount of movement of the lens is calculated in S107 and S110 in FIG. 2. In FIG. 6, the horizontal axis indicates the amount of change between sizes; situations in which the size of HBD2 increases with respect to HBD1 is indicated as “+”, while situations in which the size of HBD2 decreases with respect to HBD1 is indicated as “−”. Here, the vertical axis indicates the amount of movement of the lens 10, wherein movement to a shorter range position is indicated as “+” and movement to a longer range position is indicated as “-”. The amount of movement of the lens increases in proportion to an increase in the amount of change in sizes. In other words, when the amount of movement of the lens is +M and the amount of change is +Δ1 (i.e. when the lens 10 is moved to a shorter range position by M1 when the size becomes larger), the amount of movement of the lens 10 becomes greater than +M1 when the amount of change becomes greater than +Δ1. In this way, it is possible to move the lens 10 to a position closer to the focus position. Of course, it is also possible to set a fixed value for the amount of movement of the lens 10 regardless of the amount of change in sizes.

Further, although in this embodiment, a human body is detected using a combination of the edge of the head and the edges of the shoulders, it is also possible to use templates other than the edges 60, 62 and 64 shown in FIG. 4.

For example, when a person does not face the camera squarely, the edge of the head and the edges of the shoulders can change. However, even in such a case, it is only necessary to extract the edges of the head and the edges of the shoulders in various postures to prepare templates. Specifically, a model having typical proportions can be photographed in various postures, and the obtained edges of the head and the shoulders stored as templates. Of course, it is also possible to set the edges of the head and the shoulder in a posture facing the front as a standard template and generate templates in some postures through calculation from this standard template.

Further, although in this embodiment, a human body is detected by matching the image to templates, the human body can be detected using other methods. For example, it is also possible to detect edges, classify the detected edges into a straight-line and curved-line portions, and thereby detect a human body when the ratio of the straight-line portions to the curved-line portions falls within a fixed range. That is, it is possible to use arbitrary algorithms for determining whether or not the edges extracted from the image are edges commonly associated with human bodies.

Further, although in the example embodiment illustrated in FIG. 2, the distance to the person is measured based on the values of HBD1 or HBD2 and the focus control is performed in S112, because the size of the head, the ratio of the head to the shoulders, or the like varies according to the age, gender, and individual differences, the accuracy of the measurement of the distance is affected by the difference between individuals or the like when a standard person (such as a standard adult male) is used as a reference. For example, the following specific factors can affect the accuracy of the measurement of the distance:

(1) differences between individuals

(2) age, gender

(3) accuracy of HBD values

(4) focal length

For example, precision will decrease when the focal length is shorter (wider angle lens), because any change in head size will be smaller than the change in distance with respect to an angle of view. Depth of the field can be additionally considered in order to eliminate the influence of such factors to the extent possible. For example, as the depth of the field is shallow on a near side and deep on a rear side, by adjusting the focus to a distance shorter than the distance calculated from the HBD by a fixed rate, the subject can be kept within the depth of field, and thereby a resulting error is eliminated. This rate can be changed according to the focal length of the lens and the aperture to be used.

Although in the examples described above a digital still camera was used to illustrate the example embodiments, the present invention can be applied to a video camera in a similar manner.

The invention has been described in detail with particular reference to certain preferred embodiments thereof, but it will be understood that variations and modifications can be effected within the spirit and scope of the invention.

### PARTS LIST

10 lens
12 shutter/diaphragm
14 imaging element
16 analog preprocessing circuit
18 digital signal processing circuit
20 system control circuit
22 data bus
24 memory card
26 liquid crystal monitor
28 buffer memory
50 photographed image
52 human body
60 curved-line edge
62 curved-line edges
64 curved-line edges
66 combination

1. An imaging device comprising:
an optical system comprising a lens;
an imaging section that converts a subject image formed on the optical system to an electrical signal;
a detecting section that detects a human body using an edge pattern of an image signal obtained by the imaging section; and
a control section that drives the lens to perform focus control based on a change in a size of the human body detected in time series in a plurality of images.

2. The imaging device according to claim 1, wherein the control section performs focus control by driving the lens based on the change in the size of the human body and then driving the lens until the lens reaches a position where contrast of the image becomes maximum.

3. The imaging device according to claim 1, wherein the control section performs focus control by driving the lens based on the size of the human body when there is substantially no change in the size of the human body.

4. The imaging device according to claim 2, wherein the control section drives the lens to a shorter range position when the size of the human body increases in time series, and drives the lens to a longer range position when the size of the human body decreases in time series.

5. The imaging device according to claim 1, wherein the size of the human body comprises at least one of a length of a head, a width of the head, a length of an upper body and a width of shoulders.
